(19) United States
(12) Patent Application Publication
(10) Pub. No.: US 2023/0002270 A1
(43) Pub. Date: Jan. 5, 2023

(54) NON-FLAT FORMED GLASS, METHOD FOR PRODUCING SAME, AND USE THEREOF

(71) Applicant: SCHOTT AG, Mainz (DE)

(72) Inventors: Gerhard Lautenschläger, Jena (DE); Andreas Krieg, Jena (DE); Andreas Voitsch, Jena (DE); Axel Engel, Ingelheim (DE); Christian Pitzel, Jena (DE); Matthias Schmidt, Jena (DE); Thomas Kloss, Jena/Cospeda (DE)

(73) Assignee: SCHOTT AG, Mainz (DE)

(21) Appl. No.: 17/929,743

(22) Filed: Sep. 5, 2022

Related U.S. Application Data
(63) Continuation-in-part of application No. 16/414,982, filed on May 17, 2019, now Pat. No. 11,465,929.

(30) Foreign Application Priority Data
May 18, 2018 (DE) 10 2018 112 070.2

(51) Int. Cl. C03C 4/10; C03C 4/00; C03C 3/091; C03C 3/118

(52) U.S. Cl. CPC C03C 4/10; C03C 4/0085; C03C 3/091; C03C 3/118; C03C 2204/00

(57) ABSTRACT

A formed or non-flat formed glass is provided that exhibits high transmittance to electromagnetic radiation in a range of wavelengths from 200 nm to 1500 nm. The transmittance for the formed or non-flat formed glass having a thickness of 1 mm is 20% or more at a wavelength of 254 nm, 82% or more at a wavelength of 300 nm, 90% or more at a wavelength of 350 nm, 92% or more at a wavelength of 546 nm, 92.5% or more at a wavelength of 1400 nm, 91.5% or more in a wavelength range from 380 nm to 780 nm, and 92.5% or more in a wavelength range from 780 nm to 1500 nm.

### CROSS REFERENCE TO RELATED APPLICATIONS

This application is a continuation-in-part of U.S. application Ser. No. 16/414,982 filed on May 17, 2019, which claims benefit under 35 USC § 119 of German Application No. 10 2018 112 070.2 filed May 18, 2018, the entire contents of all of which are incorporated herein by reference.

### BACKGROUND

### Field of the Invention

The invention relates to formed glass, especially to a formed glass that is not flat, preferably to a formed glass with high transmittance for electromagnetic radiation in the wavelength range from 200 nm to 1500 nm.

### 2. DESCRIPTION OF RELATED ART

The material class of glasses has long been known.

Formed glass also has been state of the art for many years. Formed glass generally refers to a shaped body made of a vitreous material, i.e. in the form of a shaped glass. Such formed glass can be formed so as to be flat, for example like a sheet or a ribbon, and will be referred to as flat glass in this case. Known manufacturing methods for flat glass include float, rolling, and drawing processes, for example.

However, non-flat formed glasses are also known, in particular bodies with a curved or round shape such as spheres, tubes or shaped bodies of arched or curved design. Such shaped bodies differing from the flat shape will be referred to as non-flat formed glass or non-flat formed glasses in the context of the present disclosure.

Especially borosilicate glasses are of particular importance in the class of glasses. They are employed in a large variety of applications because of their special properties such as low susceptibility to temperature changes, high chemical resistance to a wide range of reagents and their good dimensional stability even at high temperatures. This glass system in particular allows to achieve specific properties, such as particularly high transmittance of the material in a specific range of wavelengths, for example in the NIR wavelength range from about 850 nm to about 1500 nm. So, because of the various options of adjusting the properties of the glass, a variety of applications and compositions of borosilicate glasses are known.

International patent application WO 2012/146860 A1 relates to the use of a borosilicate glass for induction applications and discloses both the use of an alkali borosilicate glass and the use of an alkali-free borosilicate glass. The use of borosilicate glass in particular appears advantageous because the material with low coefficients of thermal expansion, in particular expansion coefficients of 5.0*10⁻⁶/K, can be toughened thermally so that glass panels of sufficient hardness and strength for being used as a cooking surface are obtained.

Furthermore, German patent application DE 4325656 A1 discloses fire-resistant glazing of fire protection class G, in which alkali borosilicate glasses are highly toughened thermally. The Coefficient of Thermal Expansion (CTE) of such glasses is 4*10⁻⁶/K, for example. All the glasses have a rather high content of alkaline earth oxides and of ZnO and ZrO₂, ranging between 6 wt % and 10 wt %.

German patent application publication DE 101 50 884 A1 discloses an alkali borosilicate glass which is well suited for being toughened thermally. It has a coefficient of thermal expansion of 4*10⁻⁶/K, for example, and furthermore comprises the alkaline earth oxide CaO.

US 2017/0247284 A1 discloses borosilicate glasses for infrared applications such as cover plates for heaters. The examples given there for the embodiments of glasses 1 to 10 are alkali-free alkaline earth borosilicate glasses. Comparative examples 11 to 13 of US 2017/0247284 A1 include the Neoceram glass ceramic, a “Pyrex” type borosilicate glass, and an alkali-free borosilicate glass for TFT applications.

U.S. Pat. No. 9,145,333 B1 discloses compositions for alkali borosilicate glasses which are optimized for chemical toughening, that is to say for example with regard to the diffusion coefficient, compressive stress at the glass surface, etc.

Alkali borosilicate glasses also find application as a carrier substrate, for example for so-called biochips or microarrays. For example, European patent EP 1 446 362 B1 describes such a glass. This glass exhibits low intrinsic fluorescence and good UV transparency. With regard to the content of color-imparting ions, there are only limits given for the Fe₂O₃ content (of less than 150 ppm), for octahedrally bound Fe³⁺ of less than 10 ppm, and for Cr³⁺ of less than 10 ppm and preferably even less than 2 ppm. Other color-imparting elements are not limited here, in particular the transition metals of the 3rd period (i.e. of atomic numbers 21 through 30, here in particular the metals from titanium to copper). However, this does not allow to achieve glasses of high light transmittance in the entire range of wavelengths from 200 nm to 1500 nm.

In the context of the present invention, the transition metals of the 3rd period of the periodic table are also referred to as “3d elements” or “3d metals”, for short. Transition metals are understood to mean the metals of atomic numbers 21 to 30, 39 to 48, 57 to 80, and 89, and 104 to 112 in the context of the present invention.

German patent application publication DE 10 2014 119 594 A1 relates to a borosilicate glass exhibiting low brittleness and high intrinsic strength and to the production and use thereof. Optical properties such as light transmittance, refractive index, fluorescence, and solarization, or the like are neither described nor claimed. Accordingly, the content of so-called 3d elements in the glasses is not described either.

U. S. patent application US 2017/0052311 A1 discloses a glass for a light guide plate, which is an alkali borosilicate glass that is highly transparent for light in the wavelength range from 400 nm to 800 nm and free of selective unwanted light absorption. Light transmittance reducing ions of the 3d elements, such as Fe, Cr, Ni, Co, Cu, Mn, Ti, and V are said to amount to a total content of not more than 50 ppm. However, a quantification of the individual elements is not made and in particular it is not taken into account that different ions have a differently strong color-imparting effect and may interact with one another. So, the glasses which are within the composition range of the glass compositions of US 2017/0052311 A1 do not allow to create a glass that is highly transparent in the entire wavelength range from 200 nm to 1500 nm. The content of divalent iron Fe²⁺ is intended to be the lowest possible compared to the total iron content in the glasses of US 2017/0052311 A1.

U. S. patent application US 2017/0247285 A1 discloses light guide plates made of glass, wherein the glass is a high-alkali alkaline earth borosilicate glass. The glass exhibits high light transmittance in the wavelength range from 380 nm to 700 nm. For being chemically toughened, the Na₂O contents are greater than 4 mol %. B₂O₃ contents are less than 10 mol % in each case. Although the contents of some 3d elements such as Co, Ni, and Cr are limited, other 3d elements are not considered at all, for example Cu, Mn, Ti, and V. The molar ratio of Al₂O₃ to Na₂O is set to be approximately 1, due to the fact that particularly good toughening can be achieved in this way. However, a glass that is highly transparent in the entire wavelength range from 200 nm to 1500 nm is not feasible in this way.

Japanese patent JP 5540506 relates to alkali borosilicate glasses which exhibit good UV transmittance and good solarization resistance. The SiO₂ content is at most 75 wt % here. In addition to SnO₂, the composition of these glasses also includes Nb₂O₅ and As₂O₅. The content of Fe₂O₃ is between 1 ppm and 50 ppm. High light transmittance in the entire wavelength range from 200 nm to 1500 nm cannot be achieved with such glasses either.

International patent application WO 2017/070500 A1 describes a glass substrate for use as a microarray for a fluorescence detection method, which may, for example, also be suitable for microscope carrier glasses, petri dishes or other glass slides, for example with textures applied thereto or therein. All described glass substrates compulsorily have a content of B₂O₃. The achieved expansion coefficients range between 4.9 and 8.0*10⁻⁶/K. Furthermore, the glasses described in WO 2017/070500 A1 contain SnO₂.

International patent application WO 2017/070066 A1 describes the production of light guide plates from glass substrates, the glasses corresponding to those of International patent application WO 2017/070500 A1. In particular, the SiO₂ contents are between 65.79 mol % and 78.17 mol %, and the contents of B₂O₃ are between 0 and 11.16 mol % for the glass compositions described in WO 2017/070066 A1.

Japanese patent application JP 2010/208906 A relates to a glass which is stable against UV radiation with a wavelength of 365 nm. The base glass is a soda-lime glass and does not contain B₂O₃. Solarization is prevented by addition of TiO₂ in a content from 0.2 wt % to 2.0 wt %, an iron oxide content from 0.01 wt % to 0.015 wt %, and a controlled set redox ratio of Fe²⁺/Fe³⁺.

U.S. Pat. No. 4,298,389 discloses high transmittance glasses for solar applications. The optimized solar transmittance relates to the wavelength range from 350 nm to 2100 nm in this case. The base glass is an alumino-alkaline earth borosilicate glass with B₂O₃ contents from 2 wt % to 10 wt %. The Fe₂O₃ content is 200 ppm, with all iron being present in the trivalent oxidation state. UV transmittance is therefore extremely low.

U. S. patent application US 2014/0152914 A1 discloses a glass for application in touch screens, which is an aluminosilicate glass available under the brand “Gorilla” or trade name Gorilla glass.

European patent application EP 2 261 183 A2 discloses a highly transmissive glass sheet. The glass has a composition comprising Na₂O and CaO as well as SiO₂ and is free of B₂O₃. After UV irradiation, i.e. irradiation with a wavelength of up to 400 nm, this sheet is said to exhibit no reduction in transmittance in the visible spectral range.

DE 692 14 985 T2 relates to a borosilicate glass composition which is said to exhibit high spectral transmittance in the visible range but low UV transmittance. Glass sheets with such a composition serve in particular as a cover glass for gallium arsenide solar cells. The borosilicate glass has a thermal expansion coefficient of 6.4 to 7.0*10⁻⁶/K. CeO₂ is used as a UV blocker.

German patent document DE 43 38 128 C1 describes borosilicate glasses exhibiting high transmittance in the UV range and a low coefficient of thermal expansion in the range between 3.2*10⁻⁶/K and 3.4*10⁻⁶/K as well as high chemical resistance. Metallic silicon is used as a reducing agent. As a result, the fraction of Fe²⁺ compared to Fe³⁺ is high, which reduces transmittance in the near IR range.

Furthermore, German patent document DE 43 35 204 C1 describes a reducing molten borosilicate glass with high transmittance in the UV range (85% at 254 nm and at a thickness of the glass of 1 mm). The SiO₂ content is between 58 wt % and 65 wt %, and the coefficient of thermal expansion is 5 to 6*10⁻⁶/K. Carbon was used as a reducing agent in the melt.

German patent document DE 38 01 840 A1 relates to a UV-transparent borosilicate glass, for which sugar and metallic aluminum are used as the reducing agent, with a composition of 64 wt % to 66.5 wt % of SiO₂ and 20 wt % to 22.5 wt % of B₂O₃. The coefficient of thermal expansion is between 3.8*10⁻⁶/K and 4.5*10⁻⁶/K.

U.S. Pat. No. 4,925,814 describes a UV-transmissive glass comprising 60 mol % to 70 mol % of SiO₂ and 16 mol % to 20 mol % of B₂O₃. The coefficient of thermal expansion is in the range from 4.7*10⁻⁶/K to 6.2*10⁻⁶/K.

German patent application DE 10 2009 021 115 A1 discloses silicate glasses with high transmittance in the UV range. The glasses have an SiO₂ content between 65 wt % and 77 wt %, a B₂O₃ content between 0.5 wt % and 8 wt %, and furthermore a high content of alkali and alkaline earth metal ions. The coefficient of thermal expansion is between 9*10⁻⁶/K and 10*10⁻⁶/K. In order to reduce trivalent iron to divalent iron, carbon or metallic silicon is added.

German patent document DE 10 2012 219 614 B₄ discloses a solarization-resistant borosilicate glass. The composition of this glass comprises 65 wt % to 85 wt % of SiO₂ and 7 wt % to 20 wt % of B₂O₃. Solarization resistance is achieved by a defined position of the UV edge (5% transmittance at about 280 nm, 0% transmittance at 256 nm, with a thickness of the glass of 1.3 mm). Thus, the glass does not transmit UV-C radiation. The specific location of the UV edge is achieved by a combination of TiO₂, MoO₃, and V₂O₅.

German patent application publication DE 25 19 505 describes a UV-transparent borosilicate glass comprising 61 wt % to 70 wt % of SiO₂ and 0.5 wt % to 3.5 wt % of B₂O₃, and an organic reducing agent is added to the glass. After UV irradiation the glass exhibits little solarization.

German patent application publication DE 38 26 586 A1 describes UV-transmissible alkali boro-aluminosilicate glasses. The coefficient of thermal expansion is in a range from 5.2*10⁻⁶/K to 6.2*10⁻⁶/K, while the content of SiO₂ is between 58 wt % and 62 wt %, and the content of B₂O₃ is between 15 wt % and 18 wt %. UV transmittance is at least 80% at a wavelength of 254 nm for a glass having a thickness of 1 mm. However, the glasses described therein have high coefficients of thermal expansion between 5.6*10⁻⁶/K and 6.2*10⁻⁶/K.

International patent application WO 2016/115685 A1 discloses glasses with a low coefficient of thermal expansion and at the same time high UV transmittance and solarization resistance. Two types of glass are described, namely an alkali-free alkaline earth borosilicate glass with a composition of 50 mol % to 75 mol % of SiO_{2,} 5 mol % to 20 mol % of B₂O₃ and an alkaline earth oxide content of 3 mol % to 25 mol % on the one hand, and on the other an alkaline earth-free alkali borosilicate glass with a composition of 78 mol % to 85 mol % of SiO_{2,} 5 mol % to 20 mol % of B₂O₃ and an alkali oxide content between 0 mol % and 13 mol %. The coefficient of thermal expansion is in the range between 2*10⁻⁶/K and 4*10⁻⁶/K. UV transmittance is said to be improved by adjusting the number of non-bridging oxygen atoms, that is by influencing the glass network structure. In this case, a transmittance of 51% at 248 nm and 88% at 308 nm was achieved with a high-purity glass with an Fe₂O₃ content of less than 0.01 mol %. However, a comparison of the high-purity glasses with glasses having significantly higher Fe₂O₃ contents reveals that the latter exhibit significantly reduced transmittance in the UV range, namely 10% at 248 nm and 61% at 308 nm. So, other than described it appears that not so much the number of non-bridging oxygen atoms is decisive for UV transmittance, but rather the content of impurities, in particular in the form of color-imparting ions, such as iron ions. It should be noted that the cited international patent application does not make any statements regarding the content of other color-imparting ions such as other 3d elements.

International Patent Application WO 2017/119399 A1 proposes three different types of glass, which are described as being highly transmissive in the visible spectral range with wavelengths from 380 nm to 780 nm. The described glass of type A is an alkaline earth aluminosilicate glass with high alkali content, the glass of type B is a borosilicate glass with a high alkali content, and the glass of type C is an alkali-free alkaline earth borosilicate glass. A low refractive index is not feasible with these glasses; the exemplary glasses in TABLE 1 of international patent application WO 2017/119399 A1 all have a refractive index of more than 1.5.

International patent application WO 2017/052338 A1 describes a light guide plate made of glass with a composition of 75 wt % to 85 wt % of SiO₂, a B₂O₃ content of 5 wt % to 20 wt %, between 1 wt % and 5 wt % of Al₂O₃, and 3 wt % to 8 wt % of R₂O, where R stands for at least one of the elements lithium, sodium, or potassium, and less than 0.0025 wt % of Fe₂O₃.

Japanese patent application JP 2010/208906 A proposes a composition for a glass which is resistant to UV radiation. It is a soda-lime glass with a composition in the range of 66 wt % to 75 wt % of SiO₂, 0.1 wt % to 30 wt % of Al₂O₃, 5 wt % to 15 wt % of Na₂O, from 5 wt % to 15 wt % of R₂O (where R₂O is the sum of Li₂O, Na₂O, and K₂O), from 3 wt % to 10 wt % of CaO, between 0 wt % and 7 wt % of MgO, and a content of RO between 3 wt % and 18 wt % (where RO is the sum of the alkaline earth oxides CaO, MgO, BaO, and SrO), a fraction of iron oxides FeO and Fe₂O₃ between 0.005 wt % and 0.02 wt % in total, and a content of TiO₂ between 0.2 wt % and 2 wt %.

Japanese patent application JP 2015/193521 A discloses highly transmissive borosilicate glasses with a composition range of 50 wt % to 80 wt % of SiO₂, a content of 1 wt % to 45 wt % of the sum of Al₂O₃ and B₂O₃, a content between 0 wt % and 25 wt % of the sum of Li₂O, Na₂O, and K₂O, and a content between 0 wt % and 25 wt % of the sum of alkaline earth oxides MgO, CaO, SrO, and BaO. Furthermore, the sum of Fe₂O₃ and TiO₂ contents is said to be less than 100 ppm. The exemplary glasses all have a very low content of SiO₂ of about 65 wt %, and at the same time a high content of alkali oxides between about 8 wt % and 13 wt %. Accordingly, these are high-expansion glasses with a thermal expansion coefficient between about 5.5 10⁻⁶/K and 7.5*10⁻⁶/K.

International patent application WO 2016/194780 A1 describes borosilicate glasses of high transmittance for electromagnetic radiation, especially in DUV, i.e. in the range of UV-C radiation, which come from the following composition range: SiO₂ between 55 mol % and 80 mol %, B₂O₃ between 12 mol % and 27 mol %, Al₂O₃ between 0 mol % and 3.5 mol %, the sum of the contents of Li₂O, Na₂O, and K₂O between 0 mol % and 20 mol %, and a content of alkaline earth oxides RO between 0 mol % and 5 mol %. The exemplary glasses all have a high alkaline content and have coefficients of thermal expansion between 4*10⁻⁶/K and 7*10⁻⁶/K.

### SUMMARY

For modern optical applications, however, increasingly complex requirements are imposed on the material glass. Fields of application for glasses are in the field of so-called UV curing, i.e. the curing of organic coating materials such as lacquers by high-energy UV radiation in the wavelength range from 200 nm to 380 nm, in the LED sector for LEDs in the UV range for which UV-transmissive planar glass covers are needed, and for windows, filters or encapsulations, for example for NIR cameras or radar or LiDAR applications, where high transmittance for radiation in the range from 850 nm to 1500 nm wavelength is necessary. Applications which require high transmittance of the glass material for radiation in the visible wavelength range, i.e. in the range of wavelengths from about 380 nm to about 780 nm, are also of great importance, and these include, for example, cover glasses for LEDs in the wavelength range of visible light, in particular at wavelengths between 380 nm and 700 nm, so-called light guide plates, or for example for LED-based light management, in particular for generating homogeneous white light without incurring a color shift at the edge in large-format displays of the so-called “slim design” with direct backlighting and/or indirect light irradiation, and in the latter case the entire wavelength range of the visible light from about 380 nm and to about 780 nm is of particular importance.

Further applications relate to so-called microarrays for diagnostics, for example, which requires thin glass substrates with very low intrinsic fluorescence and high light transmittance in the wavelength range from 380 nm to 780 nm.

A glass with a coefficient of thermal expansion matched to silicon is needed as a carrier glass for the manufacturing of ultra-thin silicon semiconductor wafers, and this glass should allow to perform UV debonding at about 254 nm.

Microwave transmissive glass substrates with transparency for radiation in the GHz range are needed for radio frequency applications, for example for novel flat antennas with low dielectric loss factor.

Based on these modern and often innovative fields of application for glass, the following advantageous requirements arise with regard to the properties of the glass substrate to be used: High UV transparency, especially in the wavelength range from 200 nm to 300 nm; High transparency in the visible range, i.e. from 380 nm to 780 nm; High transparency in the near infrared, i.e. in the wavelength range from 780 nm to 1500 nm; Low intrinsic fluorescence; High solarization resistance; Low light scattering; Low thermal expansion coefficient; High chemical resistance and low corrosion tendency; Minimum alkali migration in the glass, in particular no alkali release at the glass surface; Good mechanical stability and high resistance against abrasive attack on the glass surface by various media; and Optimal dielectric properties: at 1 MHz ε≤5, tan σ≤50*10⁻⁴.

However, what all the glasses mentioned above have in common is that they only cover parts of the stated requirements. For example, although it is possible with a specific change in the glass composition in the range of borosilicate glasses to optimize properties for specific applications, for example with regard to the possibility of high toughening and at the same time high transmittance for electromagnetic radiation in the visual spectral range (from about 380 nm to about 800 nm wavelength), as explained above, this comes with the drawback that a glass optimized in this way is not suitable for another application, for example implying high transmittance for radiation in the UV range (from about 200 nm to about 400 nm) and at the same time high solarization resistance. On the other hand, if glasses with rather high UV transmittance are obtained, these glasses generally exhibit very high coefficients of thermal expansion, which is unfavorable for applications in the field of printed circuit board fabrication (Si debonding). However, adjustments of glass compositions to specific applications are always associated with high expenditure.

An alternative to the aforementioned glasses could be the use of pure silica glass, SiO₂, which exhibits, for example, high UV transmittance and high chemical resistance. However, applications of pure silica glass are limited by the fact that this glass is very expensive due to the complexity of its fabrication. Furthermore, silica glass cannot be produced in the form of formed glass, since it is not amenable to conventional hot forming after a melting process from a batch.

Thus, there is a need for a formed glass, in particular a non-flat formed glass that exhibits high transmittance in the wavelength range from 200 nm to 1500 nm, preferably in particular with a low coefficient of thermal expansion, high chemical resistance, and mechanical strength and low refractive index, and which can be produced at low costs.

The object of the invention is to provide a non-flat formed glass which overcomes or at least mitigates the deficiencies of the prior art.

Accordingly, the invention relates to a non-flat formed glass, wherein at a thickness of the formed glass of 1 mm the formed glass exhibits a transmittance to electromagnetic radiation which is 20% or more, preferably 60% or more, more preferably 85% or more, and most preferably 88% or more at a wavelength of 254 nm; and/or which preferably is 82% or more, preferably 90% or more, more preferably 91% or more at a wavelength of 300 nm; and/or which preferably is 90% or more, preferably 91% or more at a wavelength of 350 nm; and/or which preferably is 92% or more, preferably 92.5% or more at a wavelength of 546 nm; and/or which preferably is 92.5% or more, preferably 93% or more at a wavelength of 1400 nm; and/or which preferably is 91.5% or more, preferably 92% or more in a wavelength range from 380 nm to 780 nm; and/or which preferably is 92.5% or more, preferably 93% or more in a wavelength range from 780 nm to 1500 nm.

Thicker or thinner formed glasses also come within the scope of the invention, if these thicker or thinner formed glasses also exhibit the values according to the independent claims at a thickness of 1 mm.

For determining whether they are within the scope of protection, thicker formed glasses can be thinned out to a thickness of 1 mm.

Thinner formed glasses can also be brought to a thickness of 1 mm, by stacking and possibly thinning, so that instead of converting it is also possible to make a physical measurement of transmittance to determine whether these thin formed glasses are within this scope of protection.

So, the formed glass according to the present invention exhibits broadband high transmittance for electromagnetic wavelengths in the range of wavelengths from 200 nm to 1500 nm.

In the context of the present invention, the following definitions shall apply:

For the purposes of the present invention, formed glass is understood to mean a glass body which has a defined shape, for example is in the form of a tube. Formed glasses generally include flat glasses, for example, which are in the form of a sheet or ribbon, as well as non-flat formed glasses with a geometry differing from the flat sheet-like form.

In particular, formed glass is generally understood to mean a glass which is obtained already from the manufacturing process per se in the form of a body shaped according to a particular geometry. Therefore, not every glass body with a corresponding geometry is to be understood as a formed glass in the sense of the present invention. For example, it would also be possible to prepare a tube from a glass block by cutting and then grinding and/or polishing. More particularly, a formed glass within the scope of the present disclosure is obtained by a melting process with subsequent hot forming. For a non-flat formed glass within the meaning of the present disclosure, processes such as tube drawing according to the Vello or Danner processes are particularly suitable if the non-flat formed glass is a tube. However, other processes are also conceivable, in principle. The formed glass may generally be provided with a fire-polished surface, or else the surface may be treated after the hot-forming process in a cold post-processing step. The surface finish of the formed glass will differ depending on the selected hot forming process.

Whenever reference is made to “formed glass” in the present disclosure, this is understood to mean a non-flat formed glass, unless otherwise expressly indicated, i.e., a shaped article having a shape other than that of a flat planar sheet or a flat planar ribbon.

If reference is made to the coefficient of thermal expansion in the context of the present application, this is the coefficient of linear thermal expansion α, unless expressly stated otherwise, which is given for the range from 20° C. to 300° C. unless expressly stated otherwise. The expressions CTE, α, and α₂₀₋₃₀₀, and also generally ‘thermal expansion coefficient’ are used synonymously in the context of the present invention. The given value is the nominal coefficient of mean thermal expansion according to ISO 7991, which is determined by static measurement.

The transformation temperature T_{g} is defined by the point of intersection of the tangents to the two branches of the expansion curve when measured at a heating rate of 5 K/min. This corresponds to a measurement according to ISO 7884-8 or DIN 52324.

Thus, according to the present invention, the formed glass, in particular the non-flat formed glass is not a flat, sheet-like or ribbon-shaped glass body, but generally a non-flat formed body such as a tube or a tube section or a shaped body having a curvature, such as a channel or a ball or a ball segment. This shaped body may in particular have native surfaces. In the context of the present invention, surfaces of the glass body, i.e. those surfaces which together amount to more than half of the surface area of the shaped body (and often substantially more than this) are referred to as the surfaces of the non-flat formed glass. The edge surfaces are not understood to be surfaces in this sense. They only account for a very small percentage area of a formed glass body, in particular of a non-flat formed glass body.

The provisioning of the glass in the form of a formed glass, in particular as a non-flat formed glass according to the present invention has far-reaching advantages. Complex preparation steps are eliminated, which are not only time-consuming but also costly. Also, geometries feasible by the common formed glass, in particular non-flat formed glass, manufacturing processes are easily accessible, especially for the manufacture of hollow bodies such as tubes, or of rods, or non-flat shaped bodies, for example. Moreover, native surfaces of a glass, which are also referred to as fire-polished, determine the mechanical properties of the glass body, for example, while reworking of the surface of a glass usually leads to a significant loss in strength. So, the formed glass, in particular the non-flat formed glass according to the present invention preferably has a higher strength compared to reworked glasses.

As mentioned above, the formed glass, in particular the non-flat formed glass according to the present invention exhibits broadband high transmittance for electromagnetic radiation in the entire range of wavelengths from 200 nm to 1500 nm, and thus achieves a degree of transmittance which has previously only been achieved with optical glasses in this quality. However, compared to these optical glasses, in particular to silica glass, the formed glass, in particular the non-flat formed glass of the invention exhibits significantly enhanced meltability, especially in continuous melting units, so that it is for the first time that a glass with broadband transmittance for electromagnetic radiation in the entire wavelength range from 200 nm to 1500 nm is feasible in the form of formed glass, in particular also for non-flat formed glass, both in terms of technology and economics.

In order to ensure good meltability and thus economical production of the non-flat formed glass, the non-flat formed glass comprises a total content of oxides of network formers, in particular of oxides of silicon and/or boron, of at most 98 mol % according to one embodiment.

It is a high content of network formers, in particular of SiO₂ and/or B₂O₃, in the non-flat formed glass according to embodiments of the invention, which allows to achieve these good transmission properties of the non-flat formed glass at all. As already mentioned above, pure silica glass (also referred to as quartz glass), SiO₂, exhibits very high broadband transmittance for electromagnetic radiation. However, a melt of pure SiO₂ is not feasible technologically.

Here, network formers are understood in Zachariasen's sense, i.e. they comprise cations predominantly having a coordination number of 3 or 4. These are in particular the cations of elements Si, B, P, Ge. Hereby, network formers are distinguished from network modifiers, such as Na, K, Ca, Ba, which usually have coordination numbers of 6 and more, and from intermediate oxides such as of Al, Mg, Zn, which mostly have oxidation numbers from 4 to 6.

Furthermore, it is known that even small amounts of impurities have a drastic, namely detrimental impact on the transmission properties of silica glass. Surprisingly, however, it has been found that even with a maximum content of network formers of 98 mol %, the above-described advantageous transmission properties can already be achieved for non-flat formed glass according to embodiments.

According to one embodiment, advantageously, the coefficient of linear thermal expansion α of the non-flat formed glass ranges between 2.4*10⁻⁶/K and 3.5*10⁻⁶/K.

Such a value of the coefficient of linear thermal expansion α is advantageous because it allows to better match the coefficient of thermal expansion, for example to the silicon that is commonly used in the printed circuit board industry. If quartz glass is used, for example, which has a very low coefficient of thermal expansion of only 0.5*10⁻⁶/K, thermal cycling stress can lead to cracking of silicon layers deposited on the quartz glass substrate. With non-flat formed glass according to the present embodiment, this is significantly reduced because of the advantageous coefficient of linear thermal expansion.

According to a further embodiment of the non-flat formed glass, the non-flat formed glass has a content of SiO₂ of at least 68 mol %, preferably between 68 mol % and 85 mol %, more preferably between 72 mol % and 85 mol %, most preferably between 76 mol % and 85 mol %.

This is particularly advantageous because the meltability of the vitreous material in general is further improved in this way, which leads to good moldability and thus facilitates the production of formed glass, in particular also that of the non-flat formed glass according to embodiments. However, the content of SiO₂ of the non-flat formed glass should not be too low, in particular not less than 72 mol %, preferably not less than 76 mol %.

As is known to persons skilled in the art, simple colorless base glass systems such as silica glass (also known as quartz glass) SiO₂, but also pure borate glass B₂O₃ (and hypothetical pure phosphate glass P₂O₅, which cannot be prepared because of the high hygroscopicity of phosphorus oxide) exhibit very high transmission for radiation in the UV range. Commonly, in terms of their transmission properties, the glasses are described by the position of an absorption edge, for example the so-called UV absorption edge. The position of the absorption edge is usually specified by indicating the wavelength λ₀. The wavelength λ₀ for characterizing the UV absorption edge is the wavelength value obtained by linear extrapolation of the steeply sloping portion of the transmittance curve to the point of intersection with the X, coordinate. The λ₀ values, in nm, of some colorless base glasses are listed below:

SiO₂: λ₀=162 nm

B₂O₃: λ₀=200 nm

HPO₃: λ₀=273 nm.

Theoretically, pure phosphate glass of the composition P₂O₅ should have the smallest value for the absorption edge, however, it is impossible to prepare such glass, as stated above. The incorporation of water into glass leads to a shift of the here considered UV absorption edge towards higher wavelengths. Water-free B₂O₃ glass is also difficult to produce, so that pure water-free silica glass exhibits the highest UV transmittance of all glass systems, but as already stated, it is not feasible to prepare it in the form of formed glass, especially non-flat formed glass neither economically nor technologically.

A further shift of the transmission curve of SiO₂ or B₂O₃ base glass into the long-wave UV range is resulting when further oxides are incorporated into the SiO₂ or B₂O₃ base glasses, for example alkali oxides or alkaline earth oxides (also known as alkaline oxides). By incorporating such oxides, so-called separation site oxygen ions are generated in the glass structure (which are also referred to as “non-bridging oxygens” or NBO, for short). By way of example, the following estimation applies to the shift of the absorption edge by incorporation of a metal oxide MeₓO_{y}:

SiO₂+MeₓO_{y} shift of λ₀ from 162 nm to about 270 nm

B₂O₃+MeₓO_{y} shift of λ₀ from 200 nm to about 360 nm.

Here, “Me” refers to a metal which usually has the oxidation number y in oxides. The exact extent to which there is actually a shift in the absorption edge, in this case the UV absorption edge, depends on the nature of the metal, i.e., for example, whether it is an alkali metal or an alkaline earth metal, and for the exemplary case of alkali oxides on whether, for example, Na₂O or K₂O was specifically incorporated into the base glass.

UV absorption of the oxidic glasses primarily occurs due to the electrons of the oxygen ions, which are excited by the electromagnetic radiation. Solidly bonded oxygen ions need very high energy short-wave radiation for their excitation, whereas less solid oxygen bonds are already excited by lower energy long-wave UV radiation, especially due to the presence of the separation site oxygen ions (non-bridging oxygen, NBO).

According to one embodiment of the invention, the non-flat formed glass comprises B₂O₃, and preferably the non-flat formed glass has a content of B₂O₃ between 10 mol % and 25 mol %, most preferably between 10 mol % and 22 mol %. Although B₂O₃ in the form of pure borate glass exhibits a less favorable position of the UV absorption edge with regard to transmission properties, it has the advantage of having a lower melting point than SiO₂. However, an excessive content of B₂O₃ is unfavorable, because of the hygroscopicity of B₂O₃ and because of its tendency to evaporate from melts.

As mentioned above, pure silica glass is particularly advantageous in terms of the transmission properties of a glass, but cannot be produced in the form of a formed glass, in particular not as non-flat formed glass, for technological and economic reasons. So, if, for example for reasons of technological and/or economic feasibility of a non-flat formed glass, the total content of oxides of network formers in the formed glass is limited according to embodiments of the invention, i.e. is at most 98 mol %, and preferably not less than 85 mol %, preferably at least 87 mol %, the further components of the non-flat formed glass are of particular importance.

Therefore, according to a further embodiment of the invention, the non-flat formed glass comprises SiO₂ and B₂O₃.

In fact, it is practically feasible to obtain SiO₂ and B₂O₃ as a glass in almost any mixture together with other cations, in particular “alkaline” cations such as Na⁺, K⁺, Li⁺, Ca²⁺. However, if a glass with particularly high transmittance for electromagnetic radiation in the entire range of wavelengths from 200 nm to 1500 nm is to be achieved, in particular for example a non-flat formed glass, then it has to be considered, besides the purely practical limits given by the production conditions, in particular with regard to devitrification tendency, meltability, and/or moldability, and chemical resistance, that particularly advantageous optical properties are achieved by a high content of the oxides SiO₂ and B₂O₃ in total.

Preferably, therefore, the non-flat formed glass comprises SiO₂ and B₂O₃, and particularly preferably the following applies: Σ(SiO₂+B₂O₃) is at least 87 mol %, preferably between 87 mol % and 98 mol %, most preferably between 92 mol % and 98 mol %.

Preferably, the content of alkali oxides in the non-flat formed glass is minimized. According to one embodiment of the invention: ΣR₂O 1 mol %-6 mol %, wherein R₂O stands for alkali metal oxides.

What is decisive for particularly advantageous properties of the non-flat formed glass, in particular with regard to a particularly favorable position of the UV absorption edge (i.e. for the lowest possible λ₀) is the molar ratio of the constituents of the glass relative to each other.

According to a further embodiment, the following applies with regard to the ratio of the molar amounts of the constituents of the non-flat formed glass:

B₂O₃/SiO₂ 0.12 to 0.35, and/or

Σ(MeₓO_{y})/(Σ(SiO₂+B₂O₃) 0.02 to 0.10,

wherein Me represents a metal which usually has an oxidation number y in oxides, in particular one of an alkali metal and/or alkaline earth metal, and aluminum.

In other words, according to one embodiment, the sum of all metal oxides in the non-flat formed glass is minimized and is small compared to the sum of the main components.

Here, “Me” refers to a metal which is usually present in oxides with the oxidation number y. In particular, Me may be an alkali metal or an alkaline earth metal, or else aluminum, for example. As a matter of fact, it is also possible that the glass composition comprises a plurality of metal ions “Me”. The term “metal ion” is understood to be independent of the oxidation number, so that the non-flat formed glass may comprise the respective substance in metallic form, for example, but especially also in the form of an ion or an oxide. Usually, metals will be present in the form of ions in the oxidic glasses that are considered here. It should also be taken into account that the ions occur in different oxidation states (so-called polyvalent ions), especially in the case of the transition metals. In this sense, the wording “usual oxidation number” means the one with which a respective oxide is usually specified or designated, for example when an analysis of a composition is given. For example, the content of chromium of a glass, such as a non-flat formed glass, is usually given as a percentage of Cr₂O₃ (i.e. with the oxidation number 3 of chromium), even if other oxidation numbers are possible. In the context of the present invention, unless expressly stated otherwise, always the total content of a substance is indicated, irrespective of its oxidation state.

A molar ratio of B₂O₃ to SiO₂ within the limits between 0.12 and 0.35 is particularly advantageous because it is possible in this way to prevent or at least minimize structural inhomogeneities that might arise, for example due to demixing processes, in the system SiO₂—B₂O₃ as well as in ternary systems which comprise yet another metal oxide MeₓO_{y} in addition to SiO₂ and B₂O₃. In fact, structural inhomogeneities which may occur due to demixing processes in the form of microphase separation in a glass, for example a non-flat formed glass, also contribute to UV absorption, in particular through light scattering.

According to a further embodiment of the invention, the following applies with regard to the ratio of weight fractions of the iron ions contained in the non-flat formed glass:

0.1≤Fe²⁺/(Fe²⁺+Fe³⁺)≤0.3.

This value is also referred to as redox ratio.

In other words, the content (by mass) of bivalent iron in the non-flat formed glass is between at least 10% and at most 30%, based on the total of iron ions contained in the non-flat formed glass.

Iron constitutes an unavoidable impurity resulting from the production raw materials. And, iron is typically the major impurity, i.e. other impurities are usually contained in smaller quantities in the glass, for example a non-flat formed glass.

Surprisingly, it has been found that with a redox ratio for iron in the aforementioned limits, particularly advantageous transmission properties are achieved, especially a particularly high transmittance of the non-flat formed glass for electromagnetic radiation in the entire range of wavelengths from 200 nm to 1500 nm.

It is particularly surprising, that the advantageous high transmission properties for electromagnetic radiation are achieved just with such a redox ratio, since until now the intention has been to minimize the content of bivalent iron as far as possible. For example, for glass according to US 2017/0052311 A1, a redox ratio of preferably less than 5% was specified to be particularly preferred. However, the redox ratio precisely adjusted within the limits given above provides for an optimum trade-off, so that high transmission for a non-flat formed glass can now be achieved for UV radiation as well as in the visible and near IR range of the electromagnetic spectrum.

According to a further preferred embodiment, the content of polyvalent metal ions, for example ions of the so-called transition metals, is specifically minimized in the non-flat formed glass.

It is known that in particular polyvalent metal ions, for example ions of the so-called transition metals, may have a color-imparting effect in a glass. Although it is not possible to directly apply the ligand field theory to a glass comprising color-imparting ions, the principles of ligand field theory can similarly be applied to glasses comprising ions. However, in this case it has additionally to be taken into account that the base glass also has a significant influence on the resulting coloration, as well as other constituents contained in the glass, such as the type and concentration of any network modifiers possibly contained in the glass, for example. Therefore, the absorption ratios in a glass are difficult to predict, and generalizations are only permitted to a limited extent.

The inventor has now succeeded in determining, at least for alkali borosilicate glass with low alkali content, the color-imparting or absorption power or, more generally, the absorption behavior in the wavelength range from 200 nm to about 1500 nm of different metals or elements or ions thereof, for example of transition metals or their ions, which are frequently contained in glasses, for example as impurities. These transition metals or their ions, which are frequently contained in glasses, in particular include the transition metals of the third period of the periodic table (known as 3d elements), in particular Fe^{2+/3+}, Co²⁺, Ni²⁺, Cr³⁺, Cu²⁺, Mn²⁺, V⁵⁺, and Ti⁴⁺. As already mentioned above, the oxidation number or valence of the ions is indicated here with the oxidation numbers usually specified for the relevant element. In particular the transition metals are polyvalent ions which change from one oxidation state to another rather easily and may exist in different oxidation states, sometimes even in many different oxidation states, as is known in particular for manganese and chromium. This specific (dimensionless) color-imparting effect or, more generally, absorption power for the most frequently occurring color-imparting impurities, such as 3d transition metal ions, is listed below, based on a concentration of the respective ion of 1 ppm (by weight):

| Element | Absorption power/ppm |
|---|---|
| Fe^{2+/3+} | 1 |
| Co²⁺ | 300 |
| Ni²⁺ | 70 |
| Cr³⁺ | 50 |
| Cu²⁺ | 20 |
| Mn²⁺ | 5 |
| V⁵⁺ | 2 |
| Ti⁴⁺ | 0.5 |

Here, again, the valences of the respective metal ions are to be considered as the “most common” or “usual” oxidation state or valence. Usually, it cannot be determined in which oxidation state a polyvalent ion is actually present. It is therefore necessary to consider the total content of the respective metal or its ions in the glass composition.

The above list shows that it is not only the total content of impurities which has to be taken into account for the optical properties, for example for the absorption behavior in the range of electromagnetic wavelengths from 200 nm to 1500 nm, in particular for the absorption behavior in the range of electromagnetic wavelengths from 200 nm to 1200 nm. Rather, the contents of impurities have to be considered in a weighted manner.

Therefore, advantageously, the following applies to the glass according to one embodiment: Σ(1*Fe+300*Co+70*Ni+50*Cr+20*Cu+5*Mn+2*V) [ppm by mass] is less than 200 ppm, preferably less than 150 ppm, more preferably less than 100 ppm, yet more preferably less than 50 ppm, and most preferably less than 25 ppm, wherein the total content of the considered metals in the non-flat formed glass is considered irrespective of the oxidation state thereof.

Here, the element names represent the total content of the respective element in the non-flat formed glass, irrespective of its oxidation state, indicated in ppm, the ppm being based on the mass in each case.

This specified summary color value has to be understood as the maximum permissible limit value. So, the respective color-imparting 3d transition metal ion must not be present in any concentration. In order to achieve particularly high transmission or particularly low absorption, the contents of strongly color-imparting ions have to be adjusted in complementary manner to be lower according to their greater color-imparting effect relative to the generally higher main impurity iron (Fe) in the glass, i.e. the non-flat formed glass in this case.

Through this specific minimization of the content of strongly color-imparting metals or their ions it is possible to achieve particularly low absorption and accordingly particularly high transmission of the non-flat formed glass for electromagnetic radiation in the wavelength range from 200 nm to 1500 nm. Also, for the first time, a relationship has successfully been established between the matrix of a glass, here a borosilicate glass with low alkali content, and color-imparting impurities, and the main impurity iron.

The influence of these ions on light transmittance depends on their valence which in turn depends on the oxygen partial pressure at which the glass melt is in equilibrium. Industrial glass melts always contain a plurality of polyvalent ions at the same time, which may interact. The concentration of oxidation states may then change.

Therefore, an exchange of electrons between pairs of polyvalent ions has an enormous influence on the intended adjustment of product properties (light transmittance).

The concentration of these oxide states is influenced in particular by the purity of the glass raw materials and glass cullet; and the introduction of color-imparting 3d elements through interactions between the molten glass and the refractory material of the melting unit (glass corrosion).

What is therefore preferably used for the melting of borosilicate glasses according to embodiments of the present specification are extremely corrosion-resistant melt-cast refractory materials which have a ZrO₂ content of min. 90 wt % (generic term: HZFC—high zirconia fused cast). These materials guarantee minimal introduction of impurities into the molten glass.

Trade names of such HZFC products include, for example:

ZB—X 9510 (ASAHI/Japan) with 94,5% ZrO₂

Monofrax Z (Monofrax/U.S.A.) with 94% ZrO₂

ER 1195 (SEFPRO/France) with 94% ZrO₂.

The AZS type melt-cast refractory materials with ZrO₂ contents from 32 to 41 wt % as commonly used in industrial glass melting for special glasses do not meet the requirements.

Furthermore, preferably, what has to be used for direct glass contact at highly stressed locations (e.g. wall, flow, refining chamber, homogenization chamber, stirrer, tweel, etc.) for melting borosilicate glasses according to embodiments of the present specification are special refractory metals such as molybdenum or tungsten (manufacturer Plansee, HC Starck, etc.); and special refractory precious metal alloys such as platinum/rhodium, platinum/iridium, and platinum/gold (manufacturer Umicore/Belgium, Heraeus/DE, Tanaka/Japan etc.).

In order to meet the transmission requirements of the borosilicate glasses according to embodiments of the present specification, the impurity content in the employed raw materials has to be defined, in particular the content of 3d elements and other polyvalent ions.

In the case of the borosilicate glasses according to embodiments of the present specification, the 3d elements are introduced essentially via the SiO₂ carriers (prepared natural quartz sands), since the SiO₂ content of these glasses is about 75-80 wt %.

For example, SiO₂ carriers with Fe₂O₃ contents from 150 to 500 ppm are used for producing borosilicate glasses of the Pyrex type, i.e. a known type of commercially available borosilicate glasses.

### Example

| | |
|---|---|
| Sand- und Tonwerke Waalbeck | Qual. no. 3 max. 500 ppm Fe₂O₃ |
| | Qual. no. 3s max. 150 ppm Fe₂O₃ |

By contrast, for producing the borosilicate glasses according to embodiments of the present specification, purer SiO₂ sands have to be used.

### Examples

| | |
|---|---|
| Dorfner/Germany | Hi-Pu 005 max. 65 ppm Fe₂O₃ |
| Sigrano/The Netherlands | MAMIU max. 50 ppm Fe₂O₃ |
| Sasil/Italy | Bianco Neve max. 40 ppm Fe₂O₃ |
| The Quartz Corp./U.S.A. | SP2-C max. 30 ppm Fe₂O₃ |
| | SP2 max. 15 ppm Fe₂O₃ |
| Brementhaler Quarzit/Germany | Sipur A1 max. 10 ppm Fe₂O₃ |
| KMC Corp./Japan | 30C max. 30 ppm Fe₂O₃ |
| 5C-E | max. 5 ppm Fe₂O₃ |

These raw materials have already been used on an industrial scale, for example for producing highly transmissive borosilicate flat glasses.

The remaining borosilicate glass raw materials (carriers of Al₂O₃, alkali oxides, alkaline earth oxides, and B₂O₃) can be produced synthetically and will only introduce a small amount of 3d elements.

As a matter of course, the use of natural raw materials such as feldspar and rasorite must be dispensed with in the production of borosilicate glasses according to embodiments of the present specification.

Another source for the introduction of 3d elements is glass cullet. In the manufacturing of borosilicate glasses, cullet contents of 30 to 70% are used in the batch, for technological reasons. Only own cullet (from internal glass production, such as from quality losses, glass breakage, cutting losses, etc.) is used. This glass cullet must be prepared before reuse—crushed to about <20 mm cullet size. Glass preparation is performed in crushers (jaw crushers, roller crushers, etc.). This generates abraded matter from the crushing tools (Fe, Cr, Mn, etc.), which is introduced into the glass melt through the cullet. For producing borosilicate glasses according to embodiments of the present specification, the introduction of such abraded matter has to be minimized.

Measures for this include: removal of abraded matter using high-field magnetic separators (about 70-80% is removed); removal of abraded matter by screening the fine fraction<5 mm (about 85-95%); prevention of abrasion by crushing technologies without metallic wearing tools (counterflow processes, detonation processes, etc.); minimization of cullet content to ≤20% in the batch

Nowadays, technical borosilicate glasses are produced in glass melting tanks. The sub-processes of melting the batch, degassing, and refining are performed adjacent to one another in the same aggregate. Heating of the melting units is usually accomplished in recuperative or regenerative manner using oil or gas as a fuel and air as an oxygen supplier.

The borosilicate glasses according to embodiments of the present specification are preferably melted in oxy-fuel tanks (natural gas oxygen burners). Homogenization of the glass takes place in an aggregate arranged downstream the melting tank and made of refractory precious metal.

The oxygen chemistry of the glass melt has a great influence on the light transmittance of the molten glasses.

Oxygen partial pressure pO₂ describes the reactivity (or chemical potential) of the dissolved component oxygen in the melt.

Commercial Na—Ca formed glasses are refined using Na sulfate. This sulfate refining is always adjusted so as to be reducing, in view of good refining. Therefore, the oxygen partial pressure (pO₂) in the glass melt is low (<0.35 bar). Consequently, the content of Fe²⁺ is high, so that a blue-green color appearance is resulting due to the absorption in NIR. In order to obtain glass with less Fe²⁺, additional measures are necessary, such as chemical discoloration using CeO₂ or else Cr₂O₃: Ce⁴⁺+Fe²⁺<→Ce³⁺+Fe³⁺; or physical discoloration (overstaining) using selenium or rare earths (Er₂O₃).

However, both measures cause a decrease in transmittance in the UV-VIS.

Refining agents that are in particular used for the borosilicate glasses according to embodiments of the present specification include alkali halides, preferably NaCl.

At 1450° C. and above, evaporation of NaCl occurs. The multitude of rapidly forming/growing bubbles entails an intensive mixing of the molten glass and removes dissolved gases/N₂, H₂O, CO₂, etc.). Reducing burner setting is not required. The tank melt of borosilicate glasses according to embodiments is in particular heated with natural gas/oxygen burners.

Preheating of the O₂ carrier as in the case of air is not necessary.

The tank burners are preferably constantly operating burners, a replacement of burners as in regenerative systems is not necessary.

Usually, the tank burners are set to be slightly oxidizing.

The ratio of natural gas to O₂ is 1:2.2-2.3; a stoichiometric ratio for combustion would be approximately 1:2.1 (depending on the methane content of the natural gas). Depending on requirements, more strongly oxidizing or even reducing settings are possible.

In a borosilicate glass melting tank, 5 to 10 burners are usually arranged on both sides along the longitudinal extension of the tank. Varying the ratio of gas to O₂ enables to influence the pO₂ in the molten glass and hence to adjust the desired redox ratios of the polyvalent ions.

Preferably, the pO₂ in the molten glass is measured electrochemically by electrodes, directly through the bottom of the tank at different locations.

Further alternative or additional options for selectively adjusting the redox ratios include, for example: Use of O₂-containing raw materials which release O₂ under decomposition and offset the Fe²⁺/Fe³⁺ ratio towards Fe³⁺; Use of NaNO₃ as a Na₂O carrier instead of the commonly used Na₂CO₃; Use of KNO₃ as a K₂O carrier instead of the commonly used K₂CO₃; Bubbling using O₂ gas (gas injection)

Bubbling is a process for influencing glass flows in the melting tank by an artificially created curtain of bubbles that are steadily rising from the bottom of the tank. For this purpose, bubbling nozzles are arranged on the bottom of the tank near the source point. The bubble-producing gas (usually air or N₂) is forced through the blowing nozzles on the bottom of the tank and into the molten glass.

Preferably, pure oxygen (O₂) is used as the bubble-generating gas for borosilicate glasses according to embodiments of the present specification. This is another possibility to selectively influence the desired redox ratios, for example also by the number of nozzles, a blowing nozzle throughput from 0 to 200 1/h, the blowing nozzle pre-pressure, etc.

All these measures for adjusting a defined redox ratio are known in the art and to persons of ordinary skill in the art.

According to a further embodiment, the transformation temperature T_{g} of the non-flat formed glass is between 430° C. and 550° C., preferably between 450° C. and 550° C.

The transformation temperature T_{g} is defined by the point of intersection of the tangents to the two branches of the expansion curve when measured at a heating rate of 5 K/min. This corresponds to a measurement according to ISO 7884-8 or DIN 52324.

According to yet another embodiment, the non-flat formed glass has a viscosity wherein Ig η has a value of 4 at temperatures between 1000° C. and 1320° C. A glass of such a composition is easy to process and is in particular also suitable for a non-flat formed glass fabrication process. In particular, it is possible in this way to produce formed glasses with a particularly low surface roughness Rₐ of less than 2 nm.

Another advantage of a non-flat formed glass according to one embodiment is the low refractive index. According to one embodiment, the refractive index n_{d} of the non-flat formed glass is less than 1.479, preferably less than 1.475 at a light wavelength of 587.6 nm.

Particularly advantageously, an embodiment of the non-flat formed glass is distinguished by values of chemical resistance against water according to DIN ISO 719 class HGB 1; against acids according to DIN 12116 class S 1 W; and against alkalis according to DIN ISO 695 class A3 or better.

Such (high) values of chemical resistance of the non-flat formed glass are advantageous, since in this way the non-flat formed glass can be applied in diverse processes in which partly aggressive media might come into contact with the surface of the non-flat formed glass, for example in the chip industry, but also in other fields. In particular the low content of alkalis in the non-flat formed glass is of advantage here. However, not only the content of alkalis in a glass, e.g. a formed glass, is decisive for its chemical resistance, but also the type of bonding of the alkalis in the glass matrix. The high values for chemical resistance of the non-flat formed glass according to one embodiment are thus attributable to a low total alkali content on the one hand in combination with the particularly strong structural bonding of the alkalis in the glass matrix on the other hand.

According to another preferred embodiment, the formed glass comprises the following constituents:

SiO₂ 68 mol % to 85 mol %, preferably 72 mol % to 85 mol %, most preferably 76 mol % to 85 mol %,

B₂O₃ 10 mol % to 25 mol %, preferably 10 mol % to 22 mol %,

Al₂O₃0.2 mol % to 3.5 mol %, preferably 0.2 mol % to 2.5 mol %,

Na₂O 0.5 mol % to 5.0 mol %,

K₂O 0 mol % to 1.5 mol %, preferably 0 mol % to 1.0 mol %,

Li₂O 0 mol % to 2.5 mol %, preferably 0 mol % to 1.5 mol %,

wherein, preferably, the sum of alkali metal oxides Na₂O, K₂O, Li₂O contained in the non-flat formed glass, preferably the sum of all alkali metal oxides contained in the non-flat formed glass, amounts to less than 6 mol % and preferably less than 5 mol % in total.

According to one embodiment, the non-flat formed glass is produced or producible by a melting process with subsequent hot forming, in particular in a drawing process, for example tube drawing process such as a such as a Danner process or a Vello process.

### Examples

TABLE 1 below shows the compositions of formed glasses exhibiting high transmittance in the wavelength range from 200 nm to 1500 nm. The following TABLE 2 includes compositions of comparative glasses.

The abbreviation ‘ND’ stands for ‘not detectable’, here.

TABLE 1
Examples of selected non-flat formed glasses exhibiting high transmittance in a range of wavelengths from 200 nm to 1500 nm

| Glass | | 1 | 2 | 3 | 4 | 5 | 6 | 7 |
|---|---|---|---|---|---|---|---|---|
| SiO₂ | mol % | 83.0 | 83.0 | 83.4 | 83.4 | 83.4 | 83.2 | 83.8 |
| B₂O₃ | mol % | 11.5 | 11.5 | 11.2 | 11.2 | 11.2 | 13.3 | 12.9 |
| Al₂O₃ | mol % | 1.5 | 1.5 | 1.5 | 1.5 | 1.5 | 0.7 | 0.7 |
| Na₂O | mol % | 4.0 | 4.0 | 3.5 | 3.5 | 3.5 | 2.8 | 1.2 |
| K₂O | mol % | — | — | 0.4 | 0.4 | 0.4 | — | 0.6 |
| Li₂O | mol % | — | — | — | — | — | — | 0.8 |
| others | mol % | — | — | — | — | — | — | — |
| Σ(SiO₂ + B₂O₃) | | 94.5 | 94.5 | 94.6 | 94.6 | 94.6 | 96.5 | 96.7 |
| ΣR₂O | mol % | 4.0 | 4.0 | 4.1 | 4.1 | 4.1 | 2.8 | 2.6 |
| Σ(R₂O + Al₂O₃)/ | | 0.0582 | 0.0582 | 0.0571 | 0.0571 | 0.0571 | 0.0363 | 0.0341 |
| Σ(SiO₂ + B₂O₃) | | | | | | | | |
| B₂O₃/SiO₂ | | 0.1386 | 0.1386 | 0.1343 | 0.1343 | 0.1343 | 0.1599 | 0.1539 |
| Fe³⁺ | ppm | 50 | 70 | 30 | 5 | 1.5 | 30 | 45 |
| Cr³⁺ | ppm | 1.1 | 1.2 | 0.4 | 0.2 | 0.1 | 0.5 | 0.5 |
| Ni²⁺ | ppm | 0.1 | 0.1 | 0.02 | 0.02 | 0.02 | 0.20 | 0.25 |
| Co²⁺ | ppm | 0.05 | 0.10 | 0.01 | 0.01 | 0.01 | 0.05 | 0.1 |
| Cu²⁺ | ppm | 0.40 | 0.26 | 0.2 | 0.2 | 0.2 | 0.25 | 0.23 |
| Mn²⁺ | ppm | 1.1 | 1.3 | 0.4 | 0.3 | 0.3 | 0.4 | 0.95 |
| V⁵⁺ | ppm | 2.1 | 2.3 | 0.5 | 0.4 | 0.2 | 1.3 | 1.5 |
| Absorption | ppm | 138 | 185 | 61 | 36 | 16 | 94 | 130 |
| power | | | | | | | | |
| Ce | ppm | <1 | <1 | <1 | <1 | <1 | <1 | <1 |
| As | ppm | ND | ND | ND | ND | ND | ND | ND |
| Sb | ppm | ND | ND | ND | ND | ND | ND | ND |
| Sn | ppm | ND | ND | ND | ND | ND | ND | ND |
| S | ppm | ND | ND | ND | ND | ND | ND | ND |
| H₂O | mmol l⁻¹ | 37.6 | 36.5 | 32.5 | 33.4 | 34.2 | 31.8 | 30.6 |
| σ | g cm⁻³ | 2.22 | 2.22 | 2.22 | 2.22 | 2.22 | 2.18 | 2.175 |
| a | 10⁻⁶ K⁻¹ | 3.29 | 3.29 | 3.28 | 3.28 | 3.28 | 2.77 | 2.60 |
| Tg | ° C. | 533 | 533 | 528 | 528 | 528 | 530 | 527 |
| L4 | ° C. | 1252 | 1252 | 1275 | 1275 | 1275 | 1260 | 1283 |
| L3 | ° C. | 1504 | 1504 | 1538 | 1538 | 1538 | 1512 | 1537 |
| n_{d} | | 1.472 | 1.472 | 1.471 | 1.471 | 1.471 | 1.470 | 1.469 |
| Transmittance 1 mm | | | | | | | | |
| @ 250 nm % | | | 20.0 | 32.9 | 86.9 | 90.1 | | |
| 300 nm % | | | 82.7 | 87.1 | 92.1 | 92.2 | | |
| 546 nm % | | | 92.7 | 92.8 | 93.1 | 93.2 | | |
| 1400 nm % | | | 93.1 | 93.2 | 93.3 | 93.3 | | |
| H | ISO 719 | HGB 1 | HGB 1 | HGB 1 | HGB 1 | HGB 1 | HGB 1 | HGB 1 |
| S | ISO 1776 | S 1 | S 1 | S 1 | S 1 | S 1 | S 1 | S 1 |
| L | ISO 695 | L A2 | L A2 | L A2 | L A2 | L A2 | L A3 | L A3 |

| | | | | | | | |
|---|---|---|---|---|---|---|---|
| Dielectric constant | 4.4 | 4.4 | 4.5 | 4.5 | 4.5 | 4.1 | 4.1 |
| at 5 GHz | | | | | | | |
| Dissipation factor | 0.0038 | 0.0038 | 0.0037 | 0.0037 | 0.0037 | 0.0030 | 0.0025 |
| at 5 GHz | | | | | | | |

Examples of selected non-flat formed glasses exhibiting high transmittance in a range of wavelengths from 200 nm to 1500 nm

| Glass | | 8 | 9 | 10 | 11 | 12 | 13 |
|---|---|---|---|---|---|---|---|
| SiO₂ | mol % | 82.2 | 80.4 | 76.7 | 74.9 | 75.4 | 75.8 |
| B₂O₃ | mol % | 15.0 | 16.9 | 20.5 | 21.8 | 21.8 | 21.8 |
| Al₂O₃ | mol % | 0.6 | 0.6 | 0.6 | 0.7 | 0.7 | 0.7 |
| Na₂O | mol % | 0.5 | 0.5 | 0.5 | 1.1 | 0.6 | 0.6 |
| K₂O | mol % | 0.7 | 0.6 | 0.7 | 0.5 | 0.5 | 0.3 |
| Li₂O | mol % | 1.0 | 1.0 | 1.0 | 1.0 | 1.0 | 0.8 |
| others | mol % | — | — | — | — | — | — |
| Σ(SiO₂ + B₂O₃) | | 97.2 | 97.3 | 97.2 | 96.7 | 97.2 | 97.6 |
| ΣR₂O | mol % | 2.2 | 2.1 | 2.2 | 2.6 | 2.1 | 1.7 |
| Σ(R₂O + Al₂O₃) | | 0.0288 | 0.0277 | 0.0288 | 0.0341 | 0.0288 | 0.0246 |
| Σ(SiO₂ + B₂O₃)/ | | | | | | | |
| B₂O₃/SiO₂ | | 0.1825 | 0.2102 | 0.2373 | 0.2911 | 0.2891 | 0.2876 |
| Fe³⁺ | ppm | 15 | 35 | 25 | 9 | 5 | 7 |
| Cr³⁺ | ppm | 3.0 | 0.5 | 0.3 | 0.2 | 0.2 | 0.2 |
| Ni²⁺ | ppm | 0.15 | 0.3 | 0.2 | 0.1 | 0.1 | 0.1 |
| Co²⁺ | ppm | 0.01 | 0.1 | 0.1 | 0.05 | 0.04 | 0.04 |
| Cu²⁺ | ppm | 2.0 | 0.14 | 0.25 | 0.13 | 0.1 | 0.10 |
| Mn²⁺ | ppm | 0.3 | 0.4 | 0.35 | 0.28 | 0.25 | 0.31 |
| V⁵⁺ | ppm | 0.4 | 1.2 | 0.9 | 0.5 | 0.3 | 0.4 |
| Absorption | ppm | 48 | 118 | 93 | 46 | 38 | 40 |
| power | | | | | | | |
| Ce | ppm | <1 | <1 | <1 | <1 | <1 | <1 |
| As | ppm | ND | ND | ND | ND | ND | ND |
| Sb | ppm | ND | ND | ND | ND | ND | ND |
| Sn | ppm | ND | ND | ND | ND | ND | ND |
| S | ppm | ND | ND | ND | ND | ND | ND |
| H₂O | mmol l⁻¹ | 38.7 | 39.9 | 41.5 | 42.9 | 42.1 | 40.8 |
| σ | g cm⁻³ | 2.17 | 2.16 | 2.145 | 2.13 | 2.12 | 2.11 |
| a | 10⁻⁶ K⁻¹ | 2.65 | 2.85 | 3.07 | 3.29 | 3.04 | 2.78 |
| Tg | ° C. | 517 | 500 | 486 | 467 | 510 | 530 |
| L4 | ° C. | 1264 | 1224 | 1184 | 1143 | 1204 | 1290 |
| L3 | ° C. | 1526 | 1471 | 1430 | 1377 | 1456 | 1544 |
| n_{d} | | 1.467 | 1.466 | 1.464 | 1.465 | 1.464 | 1.463 |
| Transmittance 1 mm | | | | | | | |
| @ 250 nm % | | 63.3 | | | | | |
| 300 nm % | | 90.1 | | | | | |
| 546 nm % | | 93.0 | | | | | |
| 1400 nm % | | 93.3 | | | | | |
| H | ISO 719 | HGB 1 | HGB 1 | HGB 1 | HGB 1 | HGB 1 | HGB 1 |
| S | ISO 1776 | S 1 | S 1 | S 1 | S 1 | S 1 | S 1 |
| L | ISO 695 | L A3 | L A3 | L A3 | L A3 | L A3 | L A3 |

| | | | | | | |
|---|---|---|---|---|---|---|
| Dielectric constant | 4.1 | 4.0 | 4.0 | 3.95 | 3.9 | 3.9 |
| at 5 GHz | | | | | | |
| Dissipation factor | 0.0021 | 0.0020 | 0.0019 | 0.0018 | 0.0016 | 0.0015 |
| at 5 GHz | | | | | | |

TABLE 2
Comparative glasses

| Glass | | A | B | C | D | E | F | G | H | I | J | M |
|---|---|---|---|---|---|---|---|---|---|---|---|---|
| SiO₂ | mol % | 71.3 | 69.1 | 81.4 | 73.4 | 69.9 | 82.6 | 68.2 | 66.8 | 67.3 | 65.5 | 82.6 |
| B₂O₃ | mol % | — | — | 9.4 | — | 7.6 | 11.6 | 7.9 | — | 4.3 | — | 11.7 |
| Al₂O₃ | mol % | 0.6 | 0.2 | 2.6 | — | 2.6 | 1.3 | 10.6 | 4.4 | 12.6 | 8.4 | 1.5 |
| Na₂O | mol % | 12.7 | 13.0 | 5.0 | 8.4 | 6.4 | 4.3 | — | 4.6 | 13.8 | 12.1 | 3.8 |
| K₂O | mol % | 0.2 | 0.02 | 0.5 | 5.7 | 5.8 | 0.1 | — | 4.8 | — | 4.1 | 0.4 |
| Li₂O | mol % | — | — | — | — | — | — | — | — | — | — | — |
| MgO | mol % | 5.9 | 6.7 | — | — | — | — | 7.2 | 3.6 | 2.0 | 8.9 | — |
| CaO | mol % | 8.9 | 10.9 | 1.1 | 8.1 | — | — | 3.7 | 5.9 | | 0.2 | — |
| ZnO | mol % | — | — | — | 3.3 | 4.4 | — | — | — | — | — | — |
| SrO | mol % | — | — | — | — | — | — | 2.2 | 4.4 | — | — | — |
| BaO | mol % | — | — | — | 0.9 | — | — | — | 3.6 | — | 0.1 | — |
| TiO₂ | mol % | — | — | — | 0.2 | 3.3 | — | — | | — | | — |
| ZrO₂ | mol % | — | — | — | — | — | — | — | 1.9 | — | 0.5 | — |
| Sb₂O₃ | mol % | — | — | — | — | 0.05 | — | — | — | — | — | — |
| SnO₂ | mol % | — | — | — | — | — | — | 0.2 | — | 0.15 | — | — |
| S | mol % | 0.6 | 0.5 | — | — | — | — | — | — | — | 0.1 | — |
| Others | mol % | — | 0.018 | — | — | — | — | — | — | — | — | — |
| | | | (ER₂O₃) | | | | | | | | | |
| Fe³⁺ | ppm | 900 | 95 | 240 | 100 | 100 | 120 | 150 | 1000 | 300 | 300 | 130 |
| Cr³⁺ | ppm | | 0.9 | | | | 5 | | | | | 4 |
| Ni²⁺ | ppm | | 0.5 | | | | 2 | | | | | 3 |
| Co²⁺ | ppm | | 0.65 | | | | 2 | | | | | 2 |
| Cu²⁺ | ppm | | 1.75 | | | | 4 | | /// | | | 5 |
| Mn²⁺ | ppm | | 3.7 | | | | 2 | | | | | 2 |
| V⁵⁺ | ppm | | 1.2 | | | | 2 | | | | | 2 |
| Absorption | ppm | | 426 | | | | 1204 | | | | | 1239 |
| power | | | | | | | | | | | | |
| σ | g cm⁻³ | 2.5 | 2.51 | 2.28 | 2.55 | 2.51 | 2.23 | 2.43 | 2.77 | 2.39 | 2.48 | 2.225 |
| α | 10⁻⁶ K⁻¹ | 8.9 | 9.0 | 4.1 | 9.4 | 7.2 | 3.35 | 3.2 | 8.3 | 7.6 | 9.8 | 3.44 |
| T_{g} | ° C. | 520 | 515 | 585 | 533 | 557 | 516 | 717 | 569 | 630 | 604 | 518 |
| L4 | ° C. | 1020 | 1022 | 1271 | 1033 | 1051 | 1252 | 1295 | 1145 | | | 1251 |
| n_{d} | | 1.517 | | 1.479 | 1.5225 | 1.523 | 1.4738 | 1.51 | 1.55 | 1.5 | 1.51 | 1.48 |
| H | ISO 719 | HGB 3 | HGB 3 | HGB 1 | HGB 3 | HGB 1 | HGB 1 | HGB 3 | HGB 3 | | | HGB 3 |
| S | ISO 1776 | S 3 | S 3 | | S 1 | S 2 | S 2 | S 1 | S 4 | S 3 | | S 1 |
| L | ISO 695 | L A3 | L A3 | | L A2 | L A2 | L A2 | L A2 | L A3 | L A1 | | L A2 |

| | | | | |
|---|---|---|---|---|
| Dielectric constant | 7.6 | 4.7 | 5.1 | 4.6 |
| at 1 MHz | | | | |
| Dissipation factor | | 0.0039 | 0.0049 | 0.0049 |
| at 5 GHz 1 MHz | 0.0300 | | | |

In a particularly preferred embodiment, the glass may comprise the following constituents (in mol % on an oxide basis):

| Component | Amount (mol %) |
|---|---|
| SiO₂ | 68-73 |
| Al₂O₃ | 2-5 |
| B₂O₃ | 12-18 |
| Na₂O | 1-4 |
| K₂O | 0-2 |
| CaO | >0-2 |
| SrO | 0-1 |
| BaO | 0-4 |
| F⁻ | 0-6 |

In a further particularly preferred embodiment, the glass comprises the following constituents, in mol %:

| Component | Amount (mol %) |
|---|---|
| SiO₂ | 68-73 |
| Al₂O₃ | 3-5 |
| B₂O₃ | 12-18 |
| Li₂O | 0-2.8 |
| Na₂O | 1-4 |
| K₂O | 0-2 |
| CaO | >0-2 |
| SrO | 0-1 |
| BaO | >0-4 |
| F⁻ | 0-6 |

TABLES 3 through 6 show further exemplary glass compositions, in mol %, and further glass properties.

TABLE 3

| Component | | | | | | |
|---|---|---|---|---|---|---|
| [mol %] | 1 | 2 | 3 | 4 | 5 | 6 |
| SiO₂ | 70.07 | 67.85 | 69.04 | 70.03 | 69.70 | 69.26 |
| Al₂O₃ | 3.27 | 3.22 | 3.48 | 3.48 | 3.42 | 3.47 |
| B₂O₃ | 18.15 | 17.78 | 17.80 | 16.24 | 16.25 | 16.95 |
| Li₂O | 1.55 | 1.55 | 1.48 | 1.68 | 1.67 | 1.49 |
| Na₂O | 2.43 | 2.40 | 2.87 | 2.54 | 2.50 | 2.66 |
| K₂O | 1.02 | 1.01 | 1.22 | 0.95 | 0.94 | 1.03 |
| MgO | | 3.33 | | | | |
| CaO | 0.62 | 0.66 | 0.67 | 0.66 | 1.54 | 0.66 |
| SrO | | | | 0.02 | 0.01 | 0.01 |
| BaO | 0.47 | | 0.50 | 1.40 | 1.07 | 1.28 |
| ZnO | | | | | | |
| F⁻ | 2.27 | 2.07 | 2.75 | 2.81 | 2.70 | 2.97 |
| Cl⁻ | 0.14 | 0.13 | 0.18 | 0.19 | 0.19 | 0.21 |
| Total | 100.00 | 100.00 | 100.00 | 100.00 | 100.00 | 100.00 |
| Σ R₂O | 5.00 | 4.96 | 5.58 | 5.17 | 5.12 | 5.19 |
| Σ RO | 1.09 | 3.99 | 1.17 | 2.07 | 2.62 | 1.96 |
| Σ R₂O + Σ | 6.09 | 8.95 | 6.75 | 7.24 | 7.74 | 7.14 |
| RO | | | | | | |
| B₂O₃/Σ R₂O | 3.63 | 3.58 | 3.19 | 3.14 | 3.18 | 3.27 |
| B₂O₃/Σ RO | 16.59 | 4.46 | 15.21 | 7.83 | 6.21 | 8.67 |
| B₂O₃/Σ BaO | 38.68 | — | 35.34 | 11.63 | 15.21 | 13.23 |
| B₂O₃/(Σ RO + | 2.98 | 1.99 | 2.64 | 2.24 | 2.10 | 2.37 |
| Σ R₂O) | | | | | | |
| B₂O₃/(SiO₂ + | 0.25 | 0.25 | 0.25 | 0.22 | 0.22 | 0.23 |
| Al₂O₃) | | | | | | |
| Σ R₂O/Σ RO | 4.57 | 1.24 | 4.77 | 2.50 | 1.95 | 2.65 |
| Transmittance | 63.7 | | 55.5 | 59.7 | | 59.6 |
| @200 nm, | | | | | | |
| d = 1 mm [%] | | | | | | |
| Transmittance | 87.4 | | 75.5 | 87.8 | | 84.2 |
| @254 nm, | | | | | | |
| d = 1 mm [%] | | | | | | |
| CTE [ppm/K] | 4.14 | — | 4.42 | 4.22 | — | 4.37 |
| T_{g} [° C.] | 443 | — | 453 | 467 | — | 465 |
| T₄ [° C.] | 1085 | — | 1060 | 1090 | — | 1071 |
| CTE*T₄ | 0.0045 | — | 0.0047 | 0.0046 | — | 0.0047 |

TABLE 4

| Component | | | | | | |
|---|---|---|---|---|---|---|
| [mol %] | 7 | 8 | 9 | 10 | 11 | 12 |
| SiO₂ | 69.00 | 69.85 | 70.27 | 68.80 | 70.27 | 69.94 |
| Al₂O₃ | 3.44 | 3.43 | 3.51 | 3.37 | 3.30 | 4.82 |
| B₂O₃ | 17.44 | 18.06 | 18.25 | 17.05 | 17.83 | 15.86 |
| Li₂O | 1.67 | 1.44 | 1.67 | 1.48 | | 1.62 |
| Na₂O | 2.69 | 2.46 | 2.45 | 3.10 | 3.14 | 2.65 |
| K₂O | 1.05 | 0.97 | 0.97 | 1.69 | 1.76 | 1.26 |
| MgO | | | | | | |
| CaO | 1.12 | | 0.67 | 0.62 | 0.63 | 0.63 |
| SrO | 0.01 | | | | | |
| BaO | 0.65 | 0.49 | | 0.49 | 0.48 | 0.48 |
| ZnO | | 0.62 | | | | |
| F⁻ | 2.75 | 2.53 | 2.13 | 3.17 | 2.45 | 2.61 |
| Cl⁻ | 0.17 | 0.14 | 0.09 | 0.23 | 0.14 | 0.14 |
| Total | 100.00 | 100.00 | 100.00 | 100.00 | 100.00 | 100.00 |
| Σ R₂O | 5.41 | 4.88 | 5.09 | 6.27 | 4.90 | 5.53 |
| Σ RO | 1.78 | 0.49 | 0.67 | 1.12 | 1.11 | 1.11 |
| Σ R₂O + Σ RO | 7.19 | 5.37 | 5.76 | 7.38 | 6.01 | 6.63 |
| B₂O₃/Σ R₂O | 3.22 | 3.70 | 3.58 | 2.72 | 3.64 | 2.87 |
| B₂O₃/Σ RO | 9.78 | 36.89 | 27.39 | 15.29 | 16.06 | 14.30 |
| B₂O₃/Σ BaO | 26.67 | 36.89 | — | 34.48 | 37.08 | 32.85 |
| B₂O₃/(Σ RO + | 2.42 | 3.37 | 3.17 | 2.31 | 2.97 | 2.39 |
| Σ R₂O) | | | | | | |
| B₂O₃/(SiO₂ + | 0.24 | 0.25 | 0.25 | 0.24 | 0.24 | 0.21 |
| Al₂O₃) | | | | | | |
| Σ R₂O/Σ RO | 3.04 | 9.96 | 7.64 | 5.62 | 4.41 | 4.98 |
| Transmittance | — | 58.7 | 62.7 | 55.5 | 55.4 | 60.5 |
| @200 nm, | | | | | | |
| d = 1 mm [%] | | | | | | |
| Transmittance | — | 86.2 | 84.8 | 76.1 | 84.9 | 87.1 |
| @254 nm, | | | | | | |
| d = 1 mm [%] | | | | | | |
| CTE [ppm/K] | — | 4.16 | 4.14 | 4.72 | 4.49 | 4.4 |
| T_{g} [° C.] | — | 447 | 448 | 453 | 459 | 475 |
| T₄ [° C.] | — | 1094 | 1106 | 1035 | 1117 | 1152 |
| CTE*T₄ | — | 0.0046 | 0.0046 | 0.0049 | 0.0050 | 0.0051 |

TABLE 5

| Component | | | | | | |
|---|---|---|---|---|---|---|
| [mol %] | 13 | 14 | 15 | 16 | 17 | 18 |
| SiO₂ | 70.19 | 69.74 | 70.93 | 70.57 | 70.42 | 69.99 |
| Al₂O₃ | 4.81 | 4.29 | 3.28 | 3.83 | 3.31 | 3.51 |
| B₂O₃ | 15.86 | 16.02 | 16.00 | 14.28 | 15.91 | 16.02 |
| Li₂O | 1.62 | 1.61 | 1.58 | 1.62 | 1.61 | 1.66 |
| Na₂O | 2.43 | 2.41 | 2.35 | 2.39 | 2.43 | 2.51 |
| K₂O | 1.03 | 1.02 | 1.32 | 1.50 | 1.28 | 0.94 |
| MgO | | | | | | |
| CaO | 1.13 | 0.63 | 0.11 | 0.89 | 0.67 | 0.66 |
| SrO | | 0.02 | 0.02 | 0.02 | 0.01 | 0.02 |
| BaO | 0.48 | 1.49 | 1.45 | 1.46 | 1.22 | 1.40 |
| ZnO | | | | | | |
| F⁻ | 2.35 | 2.60 | 2.75 | 3.18 | 2.90 | 3.07 |
| Cl⁻ | 0.11 | 0.17 | 0.21 | 0.27 | 0.23 | 0.23 |
| Total | 100.00 | 100.00 | 100.00 | 100.00 | 100.00 | 100.00 |
| Σ R₂O | 5.07 | 5.04 | 5.25 | 5.51 | 5.32 | 5.11 |
| Σ RO | 1.61 | 2.14 | 1.58 | 2.37 | 1.90 | 2.07 |
| Σ R₂O + Σ RO | 6.68 | 7.18 | 6.83 | 7.88 | 7.23 | 7.18 |
| B₂O₃/Σ R₂O | 3.13 | 3.18 | 3.05 | 2.59 | 2.99 | 3.14 |
| B₂O₃/Σ RO | 9.86 | 7.49 | 10.15 | 6.03 | 8.36 | 7.72 |
| B₂O₃/Σ BaO | 33.13 | 10.77 | 11.04 | 9.75 | 13.04 | 11.46 |
| B₂O₃/(Σ RO + | 2.37 | 2.23 | 2.34 | 1.81 | 2.20 | 2.23 |
| Σ R₂O) | | | | | | |
| B₂O₃/(SiO₂ + | 0.21 | 0.22 | 0.22 | 0.19 | 0.22 | 0.22 |
| Al₂O₃) | | | | | | |
| Σ R₂O/Σ RO | 3.15 | 2.36 | 3.33 | 2.33 | 2.80 | 2.46 |
| Transmittance | 60.8 | 60.8 | 43.8 | 10.5 | 30.7 | 50.9 |
| @200 nm, | | | | | | |
| d = 1 mm [%] | | | | | | |
| Transmittance | 87.1 | 85.4 | 84.9 | 51.9 | 77.0 | 83.8 |
| @254 nm, | | | | | | |
| d = 1 mm [%] | | | | | | |
| CTE [ppm/K] | 4.18 | 4.28 | 4.25 | 4.46 | 4.28 | 4.23 |
| T_{g} [° C.] | 471 | 470 | 451 | 473 | 463 | 459 |
| T₄ [° C.] | 1164 | 1122 | 1097 | 1109 | 1086 | 1092 |
| CTE*T₄ | 0.0049 | 0.0048 | 0.0047 | 0.0049 | 0.0046 | 0.0046 |

TABLE 6

| Component | | | | | | |
|---|---|---|---|---|---|---|
| [Mol %] | 19 | 20 | 21 | 22 | 23 | 24 |
| SiO₂ | 71.33 | 71.88 | 70.92 | 71.20 | 71.85 | 71.01 |
| Al₂O₃ | 4.15 | 3.91 | 4.17 | 3.97 | 4.16 | 3.94 |
| B₂O₃ | 14.37 | 14.21 | 14.15 | 14.24 | 14.17 | 14.60 |
| Li₂O | 1.66 | 1.57 | 1.85 | 1.72 | 1.26 | 1.71 |
| Na₂O | 2.34 | 2.36 | 2.66 | 2.98 | 3.05 | 2.67 |
| K₂O | 1.23 | 1.06 | 1.21 | 1.07 | 1.06 | 1.06 |
| MgO | | | | | | |
| CaO | 0.74 | 0.56 | 0.74 | 0.56 | 0.56 | 0.56 |
| SrO | 0.01 | 0.01 | 0.01 | 0.02 | 0.01 | 0.02 |
| BaO | 1.25 | 1.25 | 1.24 | 1.25 | 1.03 | 1.22 |
| ZnO | | | | | | |
| F⁻ | 2.72 | 3.03 | 2.81 | 2.77 | 2.65 | 2.99 |
| Cl⁻ | 0.20 | 0.16 | 0.23 | 0.23 | 0.19 | 0.23 |
| Total | 100.00 | 100.00 | 100.00 | 100.00 | 100.00 | 100.00 |
| Σ R₂O | 5.23 | 5.00 | 5.72 | 5.76 | 5.37 | 5.43 |
| Σ RO | 2.01 | 1.82 | 2.00 | 1.82 | 1.61 | 1.80 |
| Σ R₂O + Σ RO | 7.23 | 6.82 | 7.71 | 7.59 | 6.98 | 7.23 |
| B₂O₃/Σ R₂O | 2.75 | 2.84 | 2.48 | 2.47 | 2.64 | 2.69 |
| B₂O₃/Σ RO | 7.16 | 7.80 | 7.09 | 7.81 | 8.82 | 8.12 |
| B₂O₃/Σ BaO | 11.48 | 11.37 | 11.37 | 11.41 | 13.72 | 11.93 |
| B₂O₃/(Σ RO + | 1.99 | 2.08 | 1.83 | 1.88 | 2.03 | 2.02 |
| Σ R₂O) | | | | | | |
| B₂O₃/(SiO₂ + | 0.19 | 0.19 | 0.19 | 0.19 | 0.19 | 0.19 |
| Al₂O₃) | | | | | | |
| Σ R₂O/Σ RO | 2.61 | 2.74 | 2.86 | 3.16 | 3.35 | 3.02 |
| Transmittance | 64.6 | 62.7 | 54.4 | 63.0 | 64.5 | 61.2 |
| @200 nm, | | | | | | |
| d = 1 mm [%] | | | | | | |
| Transmittance | 87.4 | 86.2 | 79.9 | 84.4 | 86.1 | 86.4 |
| @254 nm, | | | | | | |
| d = 1 mm [%] | | | | | | |
| CTE [ppm/K] | 4.22 | 4.1 | 4.38 | 4.36 | 4.3 | 4.29 |
| T_{g} [° C.] | 469 | 468 | 469 | 466 | 466 | 462 |
| T₄ [° C.] | 1121 | 1135 | 1101 | 1099 | 1137 | 1110 |
| CTE*T₄ | 0.0047 | 0.0047 | 0.0048 | 0.0048 | 0.0049 | 0.0048 |

TABLE 7 below shows the segregation factor for some of the glasses listed here.

TABLE 7

| | 1 | 17 | 20 | 21 | 22 |
|---|---|---|---|---|---|
| B₂O₃/BaO | 38.68 | 13.04 | 11.37 | 11.37 | 11.41 |
| Segregation | 0.4122 | 0.7391 | 1.0625 | 1.0476 | 0.9583 |
| factor | | | | | |

TABLE 8 below shows the solarization resistance (induced extinction) of glasses at 200 nm and 254 nm, respectively, after 48 hours and 96 hours of irradiation with a deuterium lamp, respectively. In each case, transmittance was measured for a glass thickness in the range from 0.70 to 0.75 mm

TABLE 8

| Induced extinction | 1 | 15 | 19 | 20 | 22 | 24 |
|---|---|---|---|---|---|---|
| 200 nm, 48 h | 0.070 | 0.129 | 0.053 | 0.031 | 0.022 | 0.018 |
| 200 nm, 96 h | 0.154 | 0.180 | 0.095 | 0.031 | 0.030 | 0.038 |
| 254 nm, 48 h | 0.025 | 0.039 | 0.015 | 0.008 | 0.008 | 0.006 |
| 254 nm, 96 h | 0.062 | 0.063 | 0.032 | 0.010 | 0.013 | 0.007 |

TABLE 9 below shows rounded transmittance values of some glasses after irradiation with a deuterium lamp for 48 h and 96 h, respectively.

TABLE 9

| Transmittance [%] | 1 | 18 | 19 | 20 | 22 | 24 |
|---|---|---|---|---|---|---|
| 200 nm, 48 h | 63.5 | 53.7 | 65.8 | 67.4 | 68.5 | 66.4 |
| 200 nm, 96 h | 58.4 | 54.7 | 63.1 | 67.4 | 67.9 | 65.1 |
| 254 nm, 48 h | 85.4 | 82.0 | 87.4 | 86.8 | 87.4 | 86.9 |
| 254 nm, 96 h | 82.3 | 81.8 | 85.9 | 86.6 | 87.0 | 86.8 |

The following TABLES 10 and 11 show fusing stresses obtained after fusing glass articles with a glass or with a metal alloy (Kovar). The glass had a CTE of 5.0 ppm/K; the metal alloy had a CTE of 5.4 ppm/K. “ppm/K” generally refers to the unit 10⁻⁶/K

TABLE 10

| Fusing stress | 1 | 15 | 16 | 17 | 18 | 19 |
|---|---|---|---|---|---|---|
| Glass, 5.0 ppm/K | 124 | 158 | 119 | 153 | 173 | 225 |
| [nm/cm] | | | | | | |
| Kovar, 5.4 ppm/K | −261 | −221 | −177 | −194 | −229 | −342 |
| [nm/cm] | | | | | | |

TABLE 11

| Fusing stress | 20 | 21 | 22 | 23 | 24 |
|---|---|---|---|---|---|
| Glass, 5.0 ppm/K | 261 | 109 | 103 | 211 | 146 |
| [nm/cm] | | | | | |
| Kovar, 5.4 ppm/K | −370 | −229 | −224 | −316 | −266 |
| [nm/cm] | | | | | |

### BRIEF DESCRIPTION OF THE DRAWINGS

FIG. 1 shows curves of spectral transmittance for electromagnetic radiation in the wavelength range from 200 nm to 1500 nm for formed glass according to the invention;

FIG. 2 shows a further transmittance spectrum in the wavelength range from 200 nm to 800 nm for the exemplary glass 8 in comparison with selected comparative glasses; and

FIG. 3 is a schematic view of a non-flat formed glass, not drawn to scale.

### DETAILED DESCRIPTION

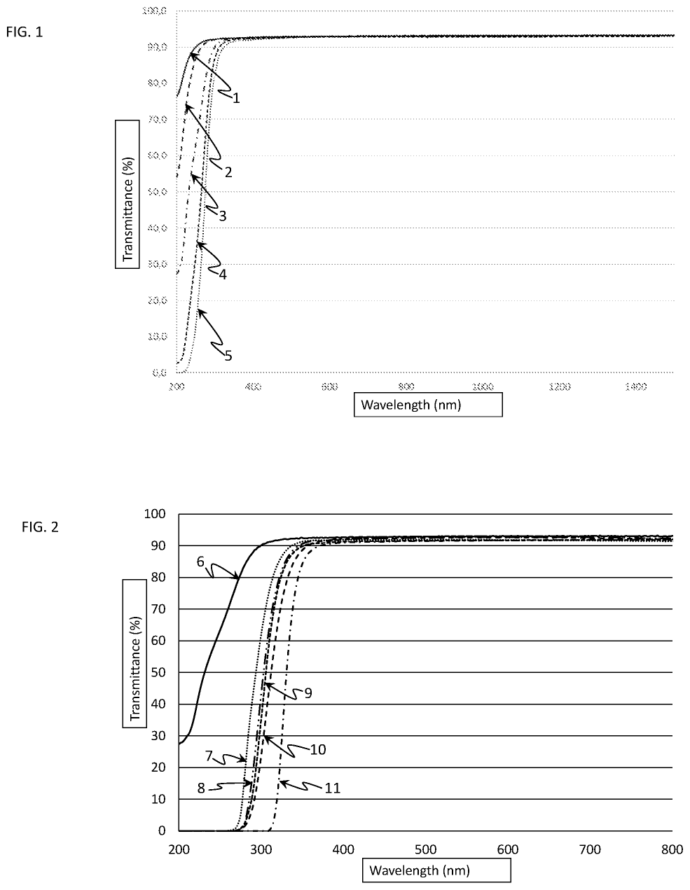

FIG. 1 shows curves of spectral transmittance of different non-flat formed glasses for a thickness of 1 mm according to different embodiments.

Transmittance curve 1 was obtained for a non-flat formed glass with a composition corresponding to glass 5 from TABLE 1.

Transmittance curve 2 was obtained for a non-flat formed glass with a composition corresponding to glass 4 from TABLE 1.

Transmittance curve 3 was obtained for a non-flat formed glass with a composition corresponding to glass 8 from TABLE 1.

Transmittance curve 4 was obtained for a non-flat formed glass with a composition corresponding to glass 3 from TABLE 1.

Transmittance curve 5 was obtained for a non-flat formed glass with a composition corresponding to glass 2 from TABLE 1.

FIG. 2 shows a further transmittance spectrum of a non-flat formed glass for a thickness of 1 mm according to one embodiment in comparison to transmittance spectra that were obtained for selected comparative glasses, again for a thickness of 1 mm. Here, the wavelength range from 200 nm to 800 nm is considered.

Transmittance curve 6 was obtained for a non-flat formed glass with a composition corresponding to glass 8 from TABLE 1.

Transmittance curve 7 was obtained for a glass of 1 mm thickness with a composition corresponding to glass B from TABLE 2.

Transmittance curve 8 was obtained for a glass of 1 mm thickness with a composition corresponding to glass F from TABLE 2.

Transmittance curve 9 was obtained for a glass of 1 mm thickness with a composition corresponding to glass D from TABLE 2.

Transmittance curve 10 was obtained for a glass of 1 mm thickness with a composition corresponding to glass I from TABLE 2.

Transmittance curve 11 was obtained for a glass of 1 mm thickness with a composition corresponding to glass E from TABLE 2.

It can clearly be seen that the non-flat formed glass according to an embodiment of the invention exhibits increased transmittance within the entire illustrated wavelength range, in comparison to the prior art glasses.

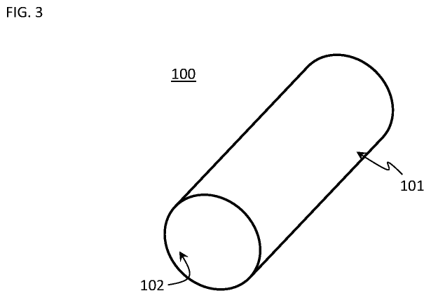

FIG. 3 is a schematic view of a non-flat formed glass 100, here in the form of a tube, not drawn to scale. The non-flat formed glass 100 comprises two surfaces 101 and 102. In the context of the present invention, the two principal surfaces of the glass body are referred to as the surfaces 101, 102 of the non-flat formed glass 100, i.e. those surfaces which account for more than 50 percent of the total surface area of the glass body of the non-flat formed glass. Here, these are the inner surface (102) and the outer surface (101) of the non-flat formed glass 100.

The non-flat formed glass 100 exhibits transmittance for electromagnetic radiation, in particular in the wavelength range from 200 nm to 1500 nm, and at a thickness of the non-flat formed glass of 1 mm the non-flat formed glass exhibits a transmittance to electromagnetic radiation which is 20% or more, preferably 60% or more, more preferably 85% or more, and most preferably 88% or more at a wavelength of 254 nm; and/or which preferably is 82% or more, preferably 90% or more, more preferably 91% or more at a wavelength of 300 nm; and/or which preferably is 90% or more, preferably 91% or more at a wavelength of 350 nm; and/or which preferably is 92% or more, preferably 92.5% or more at a wavelength of 546 nm; and/or which preferably is 92.5% or more, preferably 93% or more at a wavelength of 1400 nm; and/or which is 91.5% or more, preferably 92% or more in a wavelength range from 380 nm to 780 nm; and/or which preferably is 92.5% or more, preferably 93% or more in a wavelength range from 780 nm to 1500 nm.

According to a preferred embodiment, the non-flat formed glass 100 comprises a content of oxides of network formers, in particular of oxides of silicon and/or boron, of not more than 98 mol % in total.

Preferably, the non-flat formed glass 100 has a coefficient of linear thermal expansion a between 2.4*10⁻⁶/K and 3.5*10⁻⁶/K.

According to one embodiment, the non-flat formed glass 100 has a content of SiO₂ of at least 68 mol %, preferably between 68 mol % and 85 mol %, more preferably between 72 mol % and 85 mol %, most preferably between 76 mol % and 85 mol %.

According to a further embodiment, the non-flat formed glass 100 comprises B₂O₃, wherein preferably the content of B₂O₃ in the non-flat formed glass is between 10 mol % and 25 mol %, most preferably between 10 mol % and 22 mol %.

The non-flat formed glass 100 preferably comprises SiO₂ and B₂O₃, wherein preferably Σ(SiO₂+B₂O₃) is 87 mol % to 98 mol %, preferably 92 mol % to 98 mol %.

According to another embodiment of the non-flat formed glass 100, R₂O is between 1 mol % and 6 mol %, preferably 1 mol % to 5 mol %, wherein R₂O stands for alkali metal oxides.

With regard to the ratio of molar amounts of the components of the non-flat formed glass 100, preferably the following applies:

B₂O₃/SiO₂ 0.12 to 0.35; and/or

Σ(MeₓO_{y})/(Σ(SiO₂+B₂O₃) 0.02 to 0.10;

wherein Me represents a metal which usually has the oxidation number y in oxides, in particular one of an alkali metal and/or alkaline earth metal, and aluminum.

According to yet another embodiment of the non-flat formed glass 100, the following applies to the ratio of weight fractions of the iron ions contained in the non-flat formed glass:

0.1≤Fe²⁺/(Fe²⁺+Fe³⁺)≤0.3.

In accordance with yet another embodiment of the non-flat formed glass 100, the following applies to the metals Fe, Co, Ni, Cr, Cu, Mn, V contained in the non-flat formed glass 100 with regard to the weight fractions thereof, in ppm: Σ(1*Fe+300*Co+70*Ni+50*Cr+20*Cu+5*Mn+2*V) [ppm by mass] is less than 200 ppm, preferably less than 150 ppm, more preferably less than 100 ppm, yet more preferably less than 50 ppm, and most preferably less than 25 ppm; wherein the total content of the considered metals in the non-flat formed glass 100 is considered irrespective of their oxidation state.

Preferably, the transformation temperature T_{g} of the non-flat formed glass 100 is between 450° C. and 550° C.

According to one embodiment of the non-flat formed glass 100, it has a viscosity η and Ig η has a value of 4 at temperatures between 1000° C. and 1320° C.

According to yet another embodiment of the non-flat formed glass 100, the refractive index n_{d} of the non-flat formed glass 100 at a light wavelength of 587.6 nm is less than 1.479, preferably less than 1.475.

The non-flat formed glass 100 is preferably distinguished by values of chemical resistance against water according to DIN ISO 719 class HGB 1; against acids according to DIN 12116 class S 1 W; and against alkalis according to DIN ISO 695 class A3 or better.

According to another embodiment, the formed glass 100 comprises the following constituents:

SiO₂ 68 mol % to 85 mol %, preferably 72 mol % to 85 mol %, most preferably 76 mol % to 85 mol %,

B₂O₃ 10 mol % to 25 mol %, preferably 10 mol % to 22 mol %,

Al₂O₃0.2 mol % to 3.5 mol %, preferably 0.2 mol % to 2.5 mol %,

Na₂O 0.5 mol % to 5.0 mol %,

K₂O 0 mol % to 1.5 mol %, preferably 0 mol % to 1.0 mol %,

Li₂O 0 mol % to 2.5 mol %, preferably 0 mol % to 1.5 mol %,

wherein, preferably, the alkali metal oxides Na₂O, K₂O, Li₂O contained in the non-flat formed glass 100, preferably all alkali metal oxides contained in the non-flat formed glass 100, amount to less than 6 mol % and preferably less than 5 mol % in total.

According to one embodiment, the non-flat formed glass 100 is produced or producible by a melting process with subsequent hot forming, in particular in a drawing process, for example a tube drawing process such as a Danner process or a Vello process.

What is claimed is:

1. A non-flat formed glass comprising a transmittance to electromagnetic radiation for non-flat formed glass having a thickness of 1 mm that is 20% or more at a wavelength of 254 nm, 82 or more at a wavelength of 300 nm, 90% or more at a wavelength of 350 nm, 92% or more at a wavelength of 546 nm, 92.5% or more at a wavelength of 1400 nm, 91.5% or more in a wavelength range from 380 nm to 780 nm, and 92.5% or more in a wavelength range from 780 nm to 1500 nm.

2. The non-flat formed glass of claim 1, wherein the transmittance is 60% or more at the wavelength of 254 nm, 90% or more at the wavelength of 300 nm, 91% or more at the wavelength of 350 nm, 92.5% or more at the wavelength of 546 nm, 93% or more at the wavelength of 1400 nm, 92% or more in the wavelength range from 380 nm to 780 nm, and 93% or more in the wavelength range from 780 nm to 1500 nm.

3. The non-flat formed glass of claim 1, wherein the transmittance is 85% at the wavelength of 254 nm and 91% or more at the wavelength of 300 nm.

4. The non-flat formed glass of claim 1, wherein the transmittance is 88% or more at the wavelength of 254 nm.

5. The non-flat formed glass of claim 1, further comprising a content of oxides of network formers of not more than 98 mol % in total.

6. The non-flat formed glass of claim 5, wherein the oxides of network formers comprise oxides of silicon and/or boron.

7. The non-flat formed glass of claim 1, further comprising a coefficient of linear thermal expansion α between 2.4*10⁻⁶/K and 3.5*10⁻⁶/K.

8. The non-flat formed glass of claim 1, further comprising a content of SiO₂ of at least 68 mol %.

9. The non-flat formed glass of claim 8, wherein the content of SiO₂ is at most 85 mol %.

10. The non-flat formed glass of claim 9, wherein the content of SiO₂ is at least 76 mol %.

11. The non-flat formed glass of claim 1, further comprising a content of B₂O₃ between 10 mol % and 25 mol %.

12. The non-flat formed glass of claim 11, wherein the content of B₂O₃ is at most 22 mol %.

13. The non-flat formed glass of claim 1, further comprising Σ(SiO₂+B₂O₃) of 87 mol % to 98 mol %.

14. The non-flat formed glass of claim 13, wherein the Σ(SiO₂+B₂O₃) is at least 92 mol %.

15. The non-flat formed glass of claim 1, further comprising ΣR₂O that is between 1 mol % and 6 mol %, wherein R₂O is alkali metal oxides.

16. The non-flat formed glass of claim 1, further comprising a ratio of molar amounts of B₂O₃/SiO₂ between 0.12 to 0.35 and/or Σ(MeₓO_{y})/(Σ(SiO₂+B₂O₃) is 0.02 to 0.10, wherein Me represents a metal which usually has an oxidation number y in oxides.

17. The non-flat formed glass of claim 1, further comprising a ratio of weight fractions of ions of iron that satisfies: 0.1≤Fe²⁺/(Fe²⁺+Fe³⁺)≤0.3.

18. The non-flat formed glass of claim 1, wherein for the weight fractions, in ppm, of Fe, Co, Ni, Cr, Cu, Mn, and V, the following applies: Σ(1*Fe+300*Co+70*Ni+50*Cr+20*Cu+5*Mn+2*V) [ppm by mass] is less than 200 ppm, wherein a total content of considered metals is considered irrespective of an oxidation state thereof.

19. The non-flat formed glass of claim 1, further comprising a property selected from a group consisting of: a transformation temperature between 350° C. and 550° C.; a viscosity η wherein Ig η has a value of 4 at temperatures between 1000° C. and 1320° C.; a refractive index at a light wavelength of 587.6 nm that is less than 1.479; a value of chemical resistance against water according to DIN ISO 719 class HGB 1; a value of chemical resistance against acids according to DIN 12116 class S 1 W; and a value of chemical resistance against alkalis according to DIN ISO 695 class A3 or better.

20. The non-flat formed glass of claim 1, comprising:
SiO₂ 68 mol % to 85 mol %;
B₂O₃ 10 mol % to 25 mol %;
Al₂O₃0.2 mol % to 3.5 mol %;
Na₂O 0.5 mol % to 5.0 mol %;
K₂O 0 mol % to 1.5 mol %; and
Li₂O 0 mol % to 2.5 mol %, wherein the alkali metal oxides Na₂O, K₂O, Li₂O amount to less than 6 mol % in total.
